(19) United States
(12) Patent Application Publication
(10) Pub. No.: US 2015/0183254 A1
(43) Pub. Date: Jul. 2, 2015

(54) SILICONE BLANKET FOR PRINTING AND METHOD OF MANUFACTURING THE SAME

(71) Applicant: LG CHEM, LTD., Seoul (KR)

(72) Inventors: Jiehyun Seong, Daejeon (KR); Jooyeon Kim, Daejeon (KR); Beom Mo Koo, Daejeon (KR); Seung Heon Lee, Daejeon (KR)

(73) Assignee: LG Chem, LTD., Seoul (KR)

(21) Appl. No.: 14/403,388

(22) PCT Filed: May 29, 2013
(86) PCT No.: PCT/KR2013/004715

§ 371 Date: Nov. 24, 2014

(30) Foreign Application Priority Data
May 29, 2012 (KR) 10-2012-0056656

(51) Int. Cl. B41N 10/04

(52) U.S. Cl. CPC B41N 10/04

(57) ABSTRACT

The present specification provides a blanket for printing, including: a support layer, and a printing layer laminated on an upper portion of the support layer, in which the printing layer includes a cured material of a silicone rubber composition. The blanket for printing according to the present specification includes the cured material of the silicone rubber composition in which a —SiH group does not substantially exist on a surface to prevent a reaction with a conductive metal precursor included in an ink composition and thus suppress a discoloration phenomenon of the blanket and increase a life-span.

### TECHNICAL FIELD

The present specification relates to a silicone blanket for printing, which can suppress a discoloration phenomenon of the blanket and improve a life-span, and a method of manufacturing the same.

### BACKGROUND ART

In general, offset printing means a method where a paint image is moved from a pattern role or plate to a surface of a blanket rubber plate and the paint image of the blanket is moved again to a printing target to be indirectly printed.

A known blanket for offset printing using a silicone rubber is manufactured by using an additional curable silicone cured by reacting a polydimethylsiloxane (PDMS) having a vinyl group (—CH═CH₂), a vinyl group of PDMS having a —SiH group, and a —SiH group. If printing is repeatedly performed several times by using the blanket manufactured by the aforementioned process, there is a problem in that a discoloration phenomenon of a blanket portion stained with an ink during a printing process occurs. Particularly, a more serious phenomenon may occur when conductive metal inks, and among them, an ink based on a precursor of a conductive metal is used.

### PRIOR ART DOCUMENT

(Patent Document 1) Korean Patent Application Laid-Open No. 10-2009-0089582

### DETAILED DESCRIPTION OF THE INVENTION

### Technical Problem

If a discoloration phenomenon occurs once in a blanket, since it is difficult to return the blanket to an original state and a surface state is changed, reuse is impossible, and thus in the art, there is a demand for a research of a blanket where the discoloration phenomenon does not occur even though the blanket is used over a long period of time and a life-span is increased.

### Technical Solution

An exemplary embodiment of the present specification provides a blanket for printing, including: a support layer, and a printing layer laminated on an upper portion of the support layer, in which the printing layer includes a cured material of a silicone rubber composition. Specifically, the exemplary embodiment of the present specification provides a blanket for printing, including: a support layer, and a printing layer laminated on an upper portion of the support layer, in which the printing layer includes a cured material of a silicone rubber composition, and a value of the following Equation 1 of the silicone rubber composition is 0 or more and less than 0.001.

$$\frac{{I}_{Si - H , str}}{{I}_{{CH}_{3} , def}} \qquad [ Equation 1 ]$$

In Equation 1,

I_{Si—H,str} means an area of peaks detected in a range of 2150 to 2170 cm⁻¹ in a FT-IR spectrum, and

I_{CH}_{₃}_{,def} means an area of peaks detected in a range of 1250 to 1270 cm⁻¹ in the FT-IR spectrum.

Another exemplary embodiment of the present specification provides a method of manufacturing a blanket for printing, including: 1) preparing a support layer, and 2) applying a silicone rubber composition on the support layer and then curing the silicone rubber composition.

### Advantageous Effects

A blanket for printing according to the exemplary embodiment of the present specification includes a printing layer including a cured material of a silicone rubber composition having the aforementioned constitution, and thus a —SiH group does not substantially exist in the printing layer. Accordingly, it is possible to prevent a reaction with a conductive metal precursor included in the blanket for printing and an ink composition, suppress a discoloration phenomenon of the blanket for printing, and increase a life-span.

### BRIEF DESCRIPTION OF DRAWINGS

FIG. 1 is a view illustrating an exemplary embodiment of a blanket for printing according to the present invention.

FIG. 2 is a view obtained by observing a discoloration phenomenon of a blanket for printing according to Example 1 of the present specification.

FIG. 3 is a view obtained by observing a discoloration phenomenon of a blanket for printing according to Comparative Example 1 of the present specification.

FIG. 4 is a view illustrating a FT-IR spectrum of X-32-2100T that is a main chain of a silicone rubber composition of Example 1 of the present specification.

FIG. 5 is a view illustrating a FT-IR spectrum of CX-2100-T that is a curing catalyst of the silicone rubber composition of Example 1 of the present specification.

FIG. 6 is a view illustrating a ¹H-NMR spectrum of X-32-2100T that is the main chain of the silicone rubber composition of Example 1 of the present specification.

FIG. 7 is a view illustrating a ¹H-NMR spectrum of CX-2100-T that is a curing agent of the silicone rubber composition of Example 1 of the present specification.

FIG. 8 is a view illustrating FT-IR spectra of a main chain and a curing agent of an additional curable silicone rubber composition of Comparative Example 1 of the present specification.

FIG. 9 is a view illustrating ¹H-NMR spectra of the main chain and the curing agent of the additional curable silicone rubber composition of Comparative Example 1 of the present specification.

### BEST MODE

Hereinafter, the present specification will be described in more detail.

As described above, a known blanket for offset printing using a silicone rubber is manufactured by using an additional curable silicone cured by reacting polydimethylsiloxane (PDMS) having a vinyl group (—CH═CH₂), a vinyl group of PDMS having a —SiH group, and a —SiH group. If printing is repeatedly performed several times by using the blanket manufactured by the aforementioned process, there is a problem in that a discoloration phenomenon of a blanket portion stained with an ink during a printing process occurs. Particularly, this problem is more serious when conductive metal inks, and among them, an ink based on a precursor of a conductive metal is used.

As described above, one of reasons why the discoloration phenomenon of the blanket is more serious when the ink based on the precursor of the conductive metal is used is because the —SiH group not reacted with a surface but remaining when the blanket is manufactured acts as a reducing agent to reduce conductive metal components such as Au⁺ and Ag⁺ into Au⁰ and Ag⁰, respectively, and thus cause a surface plasmon resonance while nanoparticles are generated in the blanket.

Accordingly, the blanket for printing of the present specification has been made in an effort to solve the problem of the known blanket for printing, and to provide a blanket for printing, which has no reactivity or very low reactivity with the conductive metal precursor to suppress the discoloration phenomenon of the blanket and increase a life-span, and a method of manufacturing the same.

A blanket for printing according to an exemplary embodiment of the present specification includes a support layer, and a printing layer laminated on an upper portion of the support layer, and the printing layer includes a cured material of a silicone rubber composition.

Specifically, the exemplary embodiment of the present specification provides a blanket for printing, including: a support layer, and a printing layer laminated on an upper portion of the support layer, in which the printing layer includes a cured material of a silicone rubber composition, and a value of the following Equation 1 of the silicone rubber composition is 0 or more and less than 0.001.

$$\frac{{I}_{Si - H , str}}{{I}_{{CH}_{3} , def}} \qquad [ Equation 1 ]$$

In Equation 1,

I_{Si—H,str} means an area of peaks detected in a range of 2150 to 2170 cm⁻¹ in a FT-IR spectrum, and

I_{CH}_{₃}_{,def} means an area of peaks detected in a range of 1250 to 1270 cm⁻¹ in the FT-IR spectrum.

According to the exemplary embodiment of the present specification, a value of the following Equation 2 of the silicone rubber composition is 0 or more and less than 0.001.

A_{Si—H}/A_{Si—CH3} [Equation 2]

In Equation 2,

A_{Si—H} represents a peak area at d 4-5 ppm in a ¹H-NMR, and

A_{Si—CH3} represents a peak area at d 0-1 ppm in the ¹H-NMR.

According to the exemplary embodiment of the present specification, the silicone rubber composition includes a main chain and a curing agent.

In Equation 1 and Equation 2, in the case where the values of Equation 1 and Equation 2 are 0 or more and less than 0.001, since the —SiH group is not substantially included, the discoloration phenomenon of the blanket for printing may be suppressed, and the life-span of the blanket for printing may be increased. In the case where the values of Equation 1 and Equation 2 are 0.001 or more, a reduction in discoloration phenomenon and life-span of the blanket for printing may be caused by the —SiH group.

That is, in the case where ranges of Equation 1 and Equation 2 are 0 or more and less than 0.001, the case may mean that the —SiH group is not substantially included and also the —SiH group does not exist within an error range of an experiment.

According to the exemplary embodiment of the present specification, the silicone rubber composition includes the main chain and the curing agent. Herein, the main chain means a polymer chain including a curable functional group. The curing agent includes the functional group that can cure the main chain, and may be a unimolecule, oligomer, or polymer type.

According to the exemplary embodiment of the present specification, the silicone rubber composition is a one-fluid type or a two-fluid type. Herein, the one-fluid type is moved or stored in a state where both the main chain and the curing agent are included, and thus used to form the cured material of the silicone rubber composition. The two-fluid type means that the main chain and the curing agent are separately moved or stored and mixed immediately before the cured material of the silicone rubber composition is formed.

According to the exemplary embodiment of the present specification, the curing agent may further include a curing catalyst. Specifically, the curing agent according to the present invention may further include a tin-based compound as the curing catalyst.

According to the exemplary embodiment of the present specification, the value of Equation 1 of the printing layer is 0 or more and less than 0.001.

According to the exemplary embodiment of the present specification, the value of Equation 2 of the printing layer is 0 or more and less than 0.001.

According to the exemplary embodiment of the present specification, the printing layer does not substantially include a hydrosilyl group (—SiH).

According to the exemplary embodiment of the present specification, the silicone rubber composition does not substantially include the hydrosilyl group (—SiH).

The value of Equation 1 represents a relative content value of the hydrosilyl group (—SiH) that may exist in the silicone rubber composition or the printing layer, and the silicone rubber composition or the printing layer of the present specification does not substantially include the hydrosilyl group (—SiH).

The value of Equation 2 represents the relative content value of the hydrosilyl group (—SiH) that may exist in the silicone rubber composition or the printing layer, and the silicone rubber composition or the printing layer of the present invention does not substantially include the hydrosilyl group (—SiH).

According to the exemplary embodiment of the present specification, the support layer serves to suppress nonuniform expansion and shrinkage of a cushion layer that may exist on a lower portion of the printing layer or the support layer provided on a surface of the blanket and thus improve the degree of precision of printing, and a material that has low elasticity and can be bent to be equipped in a roll may be used for the support layer.

According to the exemplary embodiment of the present specification, the support layer includes a polymer film or a metal thin plate. To be more specific, the support layer may include the polymer film selected from the group consisting of polyethylene terephthalate (PET), polyethylene naphthalate (PEN), and polycarbonate, or the metal thin plate selected from the group consisting of aluminum and stainless steel, but is not limited thereto.

A thickness of the support layer may be 50 μm or more and 450 μm or less, but is not limited thereto.

According to the exemplary embodiment of the present specification, the printing layer serves to stain the surface of the blanket with the ink and transfer the ink. The printing layer includes the cured material of the silicone rubber composition.

According to the exemplary embodiment of the present specification, the silicone rubber composition may include one kind or more of compounds represented by the following Chemical Formula 1.

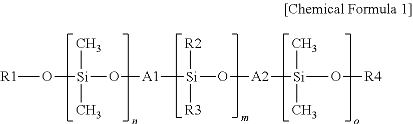

In Chemical Formula 1,

R1 and R4 are the same as or different from each other, and are each independently hydrogen, an alkyl group having 1 to 10 carbon atoms, a cycloalkyl group having 3 to 20 carbon atoms, an ethylene group, or a propylene group, or forming an epoxy group by bonding to adjacent oxygen,

R2 and R3 are the same as or different from each other, and are each independently selected from the group consisting of a hydroxy group; an alkoxy group having 1 to 10 carbon atoms; an epoxy group; an alkyl group having 1 to 10 carbon atoms unsubstituted or substituted by a halogen, an epoxy group, or an aryl group; a cycloalkyl group having to 20 carbon atoms unsubstituted or substituted by a halogen; and an aryl group having 6 to 30 carbon atoms unsubstituted or substituted by a halogen,

A1 and A2 are the same as or different from each other, and are each independently a direct bond; or an olefin-based comonomer,

n, m, and o are each independently an integer of 0 or more and 5,000 or less, but all of n, m, and o are not 0.

The substituent group of Chemical Formula 1 will be more specifically described below.

Examples of the halogen may include F, Cl, Br, and the like, but are not limited thereto.

Examples of the alkyl group may include a methyl group, an ethyl group, a propyl group, an isopropyl group, a butyl group, an isobutyl group, a pentyl group, a hexyl group, and the like, but are not limited thereto.

Examples of the cycloalkyl group may include a cyclopropyl group, a cyclohexyl group, and the like, but are not limited thereto.

Examples of the alkoxy group may include a methoxy group, an ethoxy group, a propoxy group, a butoxy group, an acetoxy group, and the like, but are not limited thereto.

Examples of the aryl group may include a phenyl group, a naphthyl group, and the like, but are not limited thereto.

Examples of the olefin-based comonomer may include ethylene, propylene, 1-butene, 1-pentene, 4-methyl-1-pentene, 1-hexene, 1-heptene, 1-octene, 1-decene, 1-undecene, 1-dodecene, 1-tetradecene, 1-hexadecene, 1-eicosene, norbornene, norbornadiene, ethylidene norbornene, phenyl norbornene, vinyl norbornene, dicyclopentadiene, 1,4-butadiene, 1,5-pentadiene, 1,6-hexadiene, and the like, but are not limited thereto.

When the silicone rubber composition is cured, R1 to R4 of Chemical Formula 1 may be bonded to each other while being hydrolyzed and thus form the cured material.

The silicone rubber composition may include two kinds or more of compounds represented by Chemical Formula 1.

At least one of R2 and R3 of Chemical Formula 1 may be selected from the group consisting of an alkyl group having 1 to 20 carbon atoms unsubstituted or substituted by a halogen; and a hydroxy group.

The silicone rubber composition includes two kinds or more of the compounds represented by Chemical Formula 1, at least one kind of the compounds represented by Chemical Formula 1 is selected from the group consisting of an alkyl group having 1 to 20 carbon atoms, in which at least one of R2 and R3 of Chemical Formula 1 is unsubstituted or substituted by a halogen; and a hydroxy group, and a content of this compound may be 10 wt % or more based on the total weight of the silicone rubber composition.

At least one of R2 and R3 of Chemical Formula 1 may be an aryl group having 6 to 30 carbon atoms unsubstituted or substituted by a halogen. In this case, strength of the cured material of the silicone rubber composition may be further increased.

n, m, and o of Chemical Formula 1 may be determined in complicated consideration of a viscosity of the silicone rubber composition, physical properties after curing, selection of R1 to R4, and the like. Particularly, in consideration of the viscosity of the silicone rubber composition, n, m, and o may be selected so that a weight average molecular weight of the silicone rubber composition does not exceed at most 1,000,000.

According to the exemplary embodiment of the present specification, the compound represented by Chemical Formula 1 may be any one of compounds represented by the following Chemical Formulas 2-1 to 2-10. However, the compound is not limited thereto.

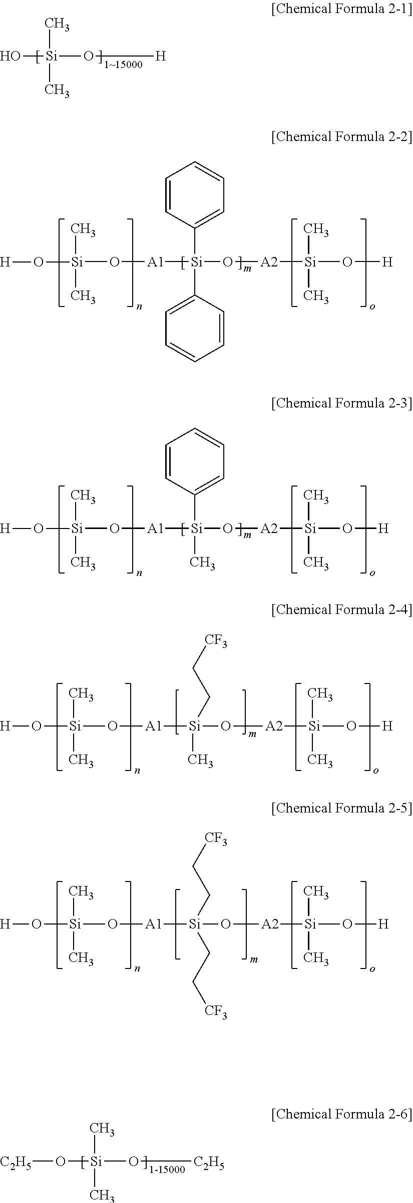

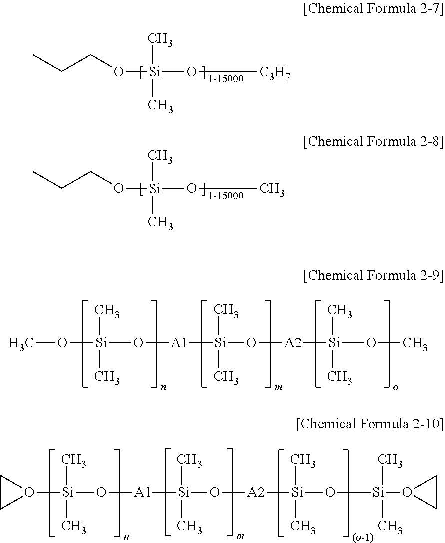

Definitions of A1, A2, n, m, and o in Chemical Formulas 2-1 to 2-10 are the same as definitions of Chemical Formula 1.

According to the exemplary embodiment of the present specification, since the compound of Chemical Formula 1 does not include the —SiH group, the reaction with the conductive metal precursor included in the blanket for printing and the ink composition may be prevented.

According to the exemplary embodiment of the present specification, the viscosity of the silicone rubber composition may be 2,500 cps or more and 100,000 cps or less, but is not limited thereto.

In the case where the viscosity of the silicone rubber composition is within the aforementioned range, a time required to apply the silicone composition on a base material and then planarize the silicone composition may be short and bubbles may be well discharged. That is, in the case where the viscosity of the silicone rubber composition is more than 100,000 cps, there are disadvantages in that the time required to apply the silicone rubber composition on the base material and then planarize the silicone rubber composition is long and it is difficult to discharge the bubbles that may be generated during a process. Further, if the viscosity of the silicone rubber composition is less than 2,500 cps, there is a disadvantage in that the entire composition flows before the silicone rubber composition is sufficiently cured after coating and thus it is difficult to perform adjustment to a desired thickness.

According to the exemplary embodiment of the present specification, the total weight average molecular weight of the silicone rubber composition may be 1,000 or more and 1,000,000 or less, preferably 2,000 or more and 500,000 or less, and more preferably 2,000 or more and 50,000 or less. However, the total weight average molecular weight is not limited thereto. The total weight average molecular weight may include both cases where the silicone rubber composition is the one-fluid type and the two-fluid type.

According to the exemplary embodiment of the present specification, in the case where the main chain and the curing agent are the two-fluid type, the weight average molecular weight of the main chain may be 1,000 or more and 1,000,000 or less, preferably 2,000 or more and 500,000 or less, and more preferably 2,000 or more and 50,000 or less. However, the weight average molecular weight is not limited thereto.

According to the exemplary embodiment of the present specification, in the case where the silicone rubber composition is the two-fluid type, the weight average molecular weight of the curing agent may be 500 or more and 100,000 or less, and more preferably 1,000 or more and 10,000 or less, but is not limited thereto.

According to the exemplary embodiment of the present specification, in the case where the silicone rubber composition is the two-fluid type, the weight average molecular weight of the main chain may be 1,000 or more and 1,000,000 or less, and the weight average molecular weight of the curing agent may be 500 or more and 100,000 or less.

In the case where the molecular weight of the silicone rubber composition is within the aforementioned range, an appropriate hardness after curing may be secured. Specifically, the hardness may be maintained within a shore A hardness range as will be described below. That is, in the case where the molecular weight of the silicone rubber composition is less than 1,000 or more than 1,000,000, it is difficult for the viscosity of the composition to have a value within 2,500 cps to 100,000 cps, and for a shore A hardness after curing to have a value within 20 to 70.

According to the exemplary embodiment of the present specification, KE-347, KE-348, KE-445, or KE-3475 manufactured by ShinEtsu Co., Ltd. may be used alone as the silicone rubber composition. KE-347, KE-348, KE-445, or KE-3475 may be the one-fluid type.

According to the exemplary embodiment of the present specification, in the silicone rubber composition, X-32-2256 and CX-32-2256 manufactured by ShinEtsu, Co., Ltd. may be used as the main chain and the curing agent, respectively, X-32-2100T and CX-2100T may be used as the main chain and the curing agent, respectively, or KE-1417 and CAT-1417-40 may be used as the main chain and the curing agent, respectively. In this case, the main chain and the curing agent may be the two-fluid type.

The shore A hardness of the printing layer may be 20 or more and 70 or less, but is not limited thereto. The shore A hardness can be measured by a method based on a ASTM D2240 test method as a method of measuring a hardness by using an insertion depth of an iron tip when predetermined force is applied.

In the case where the hardness of the printing layer is within the aforementioned range, printing may be uniformly performed well, and a pressure may be uniformly dispersed when the blanket comes into contact with a printing plate and a body to be printed. That is, in the case where the hardness of the printing layer exceeds 70, since it is difficult to perform conformal contact with the body to be printed, a region where printing is not performed occurs, or it is difficult to uniformly disperse the pressure when the blanket comes into contact with the printing plate and the body to be printed during printing. Moreover, in the case where the hardness of the printing layer is less than 20, straightness of a printing pattern is not good during printing, and a bottom contact phenomenon where the blanket comes into contact with the bottom of the printing plate during an inversion offset printing process occurs, and thus a desired pattern is not printed.

According to the exemplary embodiment of the present specification, the thickness of the printing layer may be 100 μm or more and 800 μm or less, but is not limited thereto. Further, for smooth printing, a standard deviation of the thicknesses of the printing layer may be less than 30 μm.

In the case where the thickness of the printing layer is within the aforementioned range, a leveling characteristic is excellent, and printing uniformity is excellent. That is, in the case where the thickness of the printing layer is less than 100 mm, since a coating amount of the silicone rubber composition that is a liquid phase should be very small, the leveling characteristic is not good, and the thickness deviation of the surface printing layer is relatively large as compared to the total thickness, and thus printing uniformity is not good. Further, there is a disadvantage in that in the case where the thickness of the printing layer is less than 100 mm, since a capacity of the printing layer absorbing a solvent in the ink is small, the blanket is easily swollen by the ink from an early stage of printing.

According to the exemplary embodiment of the present specification, the shore A hardness of the printing layer may be 20 or more and 70 or less, and the thickness may be 100 μm or more and 800 μm or less.

According to the exemplary embodiment of the present specification, the blanket for printing may further include a cushion layer on a lower portion of the support layer.

The cushion layer serves to relieve a nip pressure and distribute the pressure, and may be formed by using a material known in the art. To be more specific, the material may be the same as a material forming the printing layer, and a silicone rubber including polydimethylsiloxane as a basic material in the related art may be used.

The cushion layer may include foaming particles in order to increase a sense of cushion. As the foaming particles, a matter where an internal hole is formed in a polymer resin skin may be used, the size of the particle is not particularly limited, but the particle having the size of 50 μm or more and 150 μm or less may be used in order to favorably exhibit an adjustment effect of a printing pressure. By adding the foaming particles to the cushion layer, a printing pressure margin region of the blanket during printing, that is, a printing pressure range of uniform pattern printing may be further expanded, and durability of the surface printing layer of the blanket may be improved.

According to the exemplary embodiment of the present specification, the thickness of the cushion layer may be 450 μm or more and 1,200 μm or less, but is not limited thereto.

According to the exemplary embodiment of the present specification, the blanket for printing may further include a primer layer in order to increase attachment between the support layer and the printing layer; and between the support layer and the cushion layer.

According to the exemplary embodiment of the present specification, the total thickness of the blanket for printing may be 0.6 mm or more and 2.45 mm or less, but is not limited thereto. In the case where the thickness of the blanket for printing is less than 0.6 mm, since the coating amount of the liquid phase silicone rubber is small, a leveling property is not good during curing, and thus thickness uniformity is reduced, which is not preferable, and in the case where the thickness is more than 2.45 mm, when the blanket is wound around a main roll, the blanket is not appropriately bent but may be folded, which is not preferable.

According to the exemplary embodiment of the present specification, the blanket for printing includes the cured material of the silicone rubber composition in which the —SiH group does not substantially exist on the surface to prevent the reaction with the conductive metal precursor included in the ink composition and thus suppress a discoloration phenomenon of the blanket and increase a life-span.

Further, according to the exemplary embodiment of the present specification, a method of manufacturing a blanket for printing includes 1) preparing a support layer, and 2) applying a silicone rubber composition on the support layer and then curing the silicone rubber composition.

According to the exemplary embodiment of the present specification, the silicone rubber composition of the manufacturing method may include one kind or more of compounds represented by Chemical Formula 1.

According to the exemplary embodiment of the present specification, in the method of manufacturing the blanket for printing, since the contents of the support layer, the silicone rubber composition, and the like are the same as the aforementioned contents, a specific description thereof will be omitted.

According to the exemplary embodiment of the present specification, in the method of manufacturing the blanket for printing, a method known in the art may be used as a method of applying the silicone rubber composition of step 2). For example, a method such as blade coating, slot die coating, bar coating, comma coating, baker applicator coating, and curtain coating may be used, but is not limited thereto.

The silicone rubber composition may be applied and then cured under a curing condition suitable for a characteristic of the composition in step 2) to manufacture the blanket for printing. For example, the composition may be left at only room temperature for 24 hours or more, cured at 150° C. within 30 minutes, or cured at a temperature between room temperature and 150° C. In general, if the temperature is increased, a curing time is reduced, but there is a disadvantage in that it is difficult to discharge bubbles formed during a process, and if the temperature is reduced, there is an advantage in that the bubbles are easily discharged, but there is a disadvantage in that a tact time is increased.

According to the exemplary embodiment of the present specification, in the method of manufacturing the blanket for printing, the silicone rubber composition may include one kind or more of compounds represented by the Chemical Formula 1.

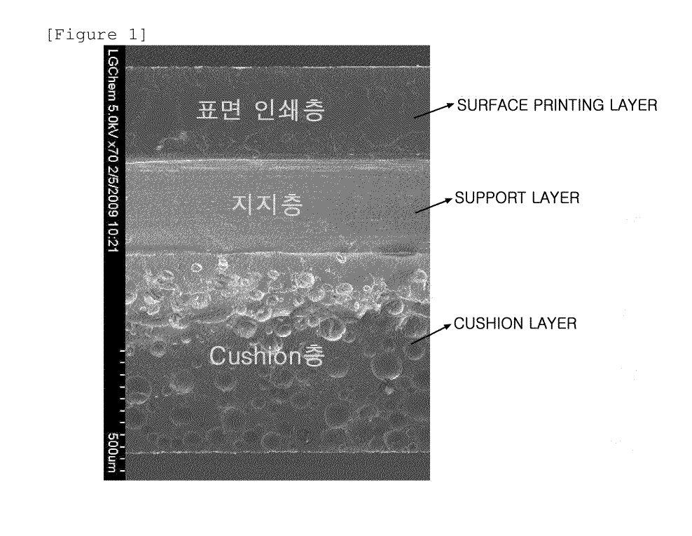

The exemplary embodiment of the blanket for printing according to the exemplary embodiment of the present specification is illustrated in the following FIG. 1.

Hereinafter, the present specification will be more specifically described through the Examples. However, the following Examples are set forth to illustrate the present specification, but the scope of the present specification is not limited to the following Examples.

### EXAMPLE

The silicone rubber composition obtained by mixing X-32-2100T and CX-2100-T (all ShinEtsu Co., Ltd.) at a weight ratio of 10:1 was applied in a thickness of 500 μm on one surface of the polyethylene terephthalate (PET) film by using the applicator, left at room temperature for 24 hours, and cured in the convection oven at 60° C. for one day to manufacture the silicone blanket for printing.

The conductive ink containing 40 parts by weight of silver neodecanate that was the silver precursor, 40 parts by weight of terpinol, and 20 parts by weight of methanol was applied on the manufactured blanket for printing by using the mayor bar. After application, the ink was dried for the waiting time of about 5 minutes, the applied ink was transferred on the glass, and whether there was the discoloration phenomenon of the surface of the blanket or not was observed.

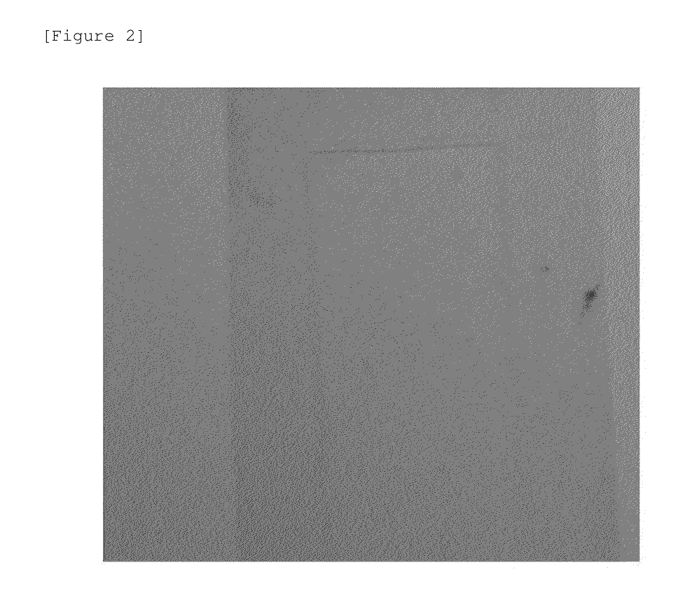

The observation result of the discoloration phenomenon of the surface of the blanket manufactured in Example 1 is illustrated in the following FIG. 2.

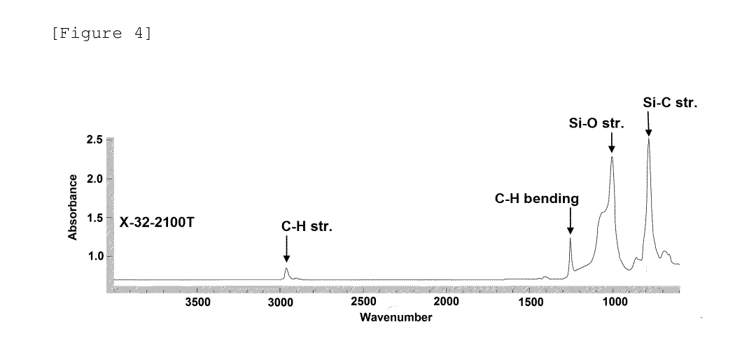

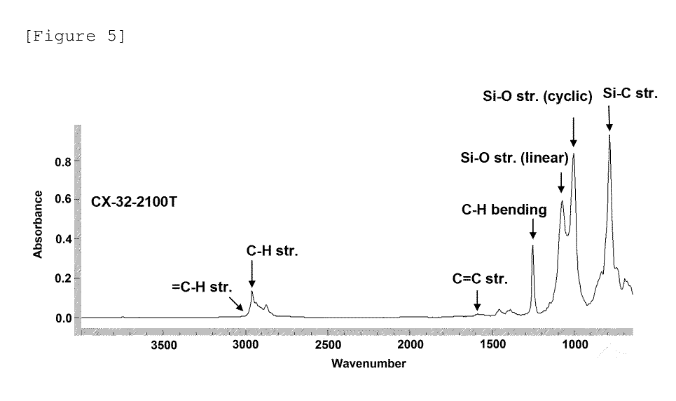

FT-IR spectra of X-32-2100T (main chain) and CX-2100-T (curing agent) that are each component of the silicone rubber composition used in Example 1 are illustrated in the following FIG. 4 and FIG. 5. According to the results of FIG. 4 and FIG. 5, it can be seen that any component of the silicone rubber composition used in Example 1 does not have the peak corresponding to Si—H.

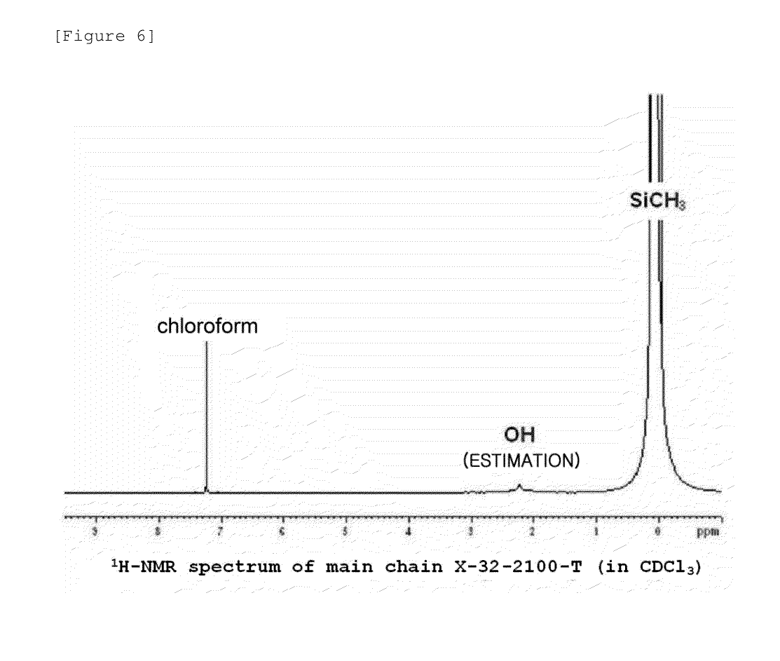

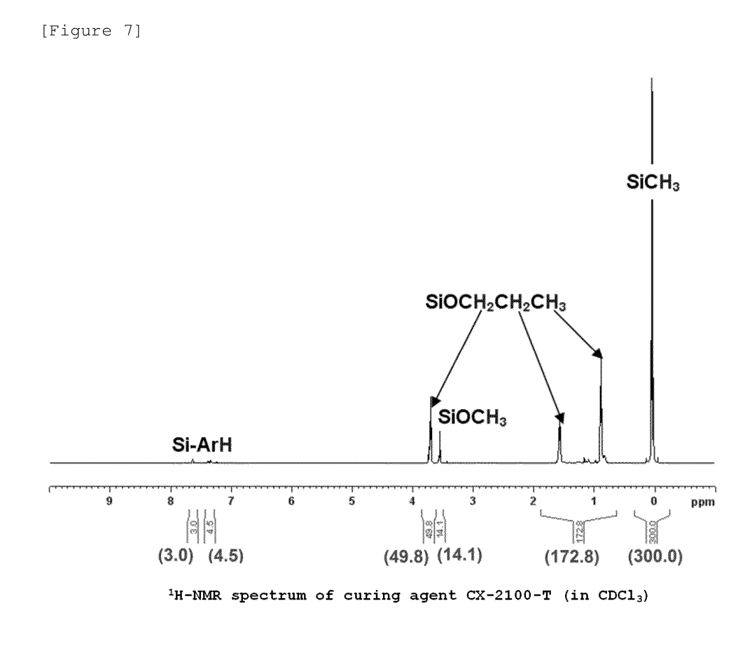

The following FIG. 6 and FIG. 7 are ¹H-NMR spectra of X-32-2100T (main chain) and CX-2100-T (curing agent) that are each component of the silicone rubber composition used in Example 1. According to the results of FIG. 6 and FIG. 7, it can be seen that any component of the silicone rubber composition used in Example 1 does not have the peak corresponding to Si—H.

### Comparative Example

The same procedure as Example 1 was performed to manufacture the blanket for printing, except that the Sylgard 184 set manufactured by Dow Corning Corporation, which was the additional curable silicone, was used when the printing layer was manufactured in Example 1. Further, similarly Example 1, the conductive ink containing the silver precursor was applied on the blanket for printing, and transferred on the glass and then whether there is the discoloration phenomenon of the surface of the blanket or not was observed.

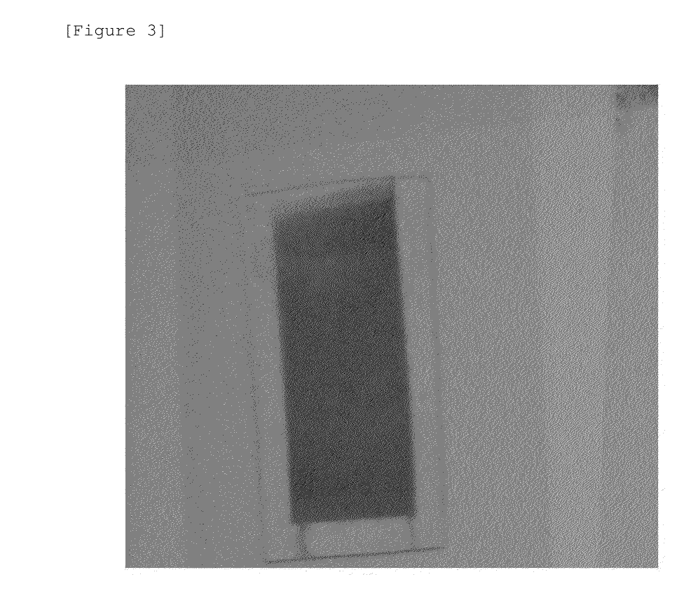

The observation result of the discoloration phenomenon of the surface of the blanket manufactured in Comparative Example 1 is illustrated in the following FIG. 3.

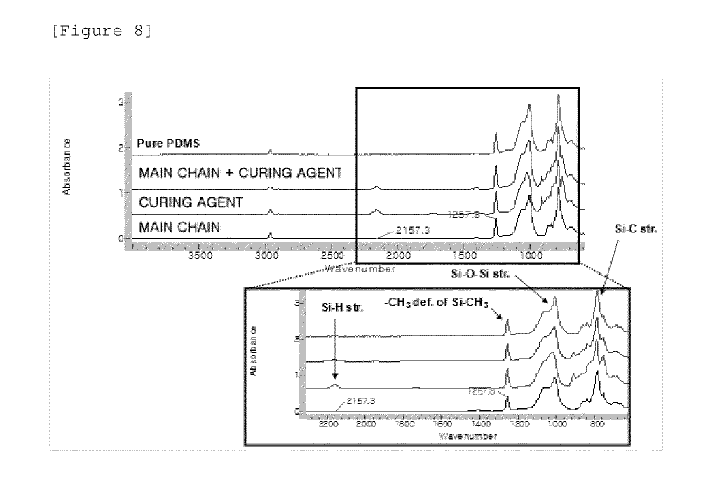

FT-IR spectra of Sylgard 184 A (main chain) and Sylgard 184 B (curing agent) that are each component of the additional curable silicone rubber composition set used in Comparative Example 1 are illustrated in the following FIG. 8. In FIG. 8, [main chain+curing agent] represents the IR spectrum result of the mixture of the main chain:the curing agent (10:1) used to manufacture the blanket. According to the result of FIG. 8, it can be seen that in the additional curable silicone rubber composition used in Comparative Example 1, the peak corresponding to Si—H is not detected in the main chain but the peak corresponding to Si—H is detected in a respectable amount in the curing agent, and even though the main chain and the curing agent are mixed at a weight ratio of 10:1 that is a ratio recommended by the enterprise, a respectable amount of Si—H remains. In the FT-IR spectrum measured after the main chain and the curing agent were mixed at the ratio of 10:1 and cured for two days, when the ratio of the peak area corresponding to Si—H stretching and the peak area corresponding to —CH₃ deformation was set, the value of the following Equation 1 was calculated to be 0.023. Reviewing this, it can be seen that the Si—H group remains in a small amount even after curing.

$$\frac{{I}_{Si - H , str}}{{I}_{{CH}_{3} , def}} \qquad [ Equation 1 ]$$

In the following FIG. 8, Pure PDMS represents the IR spectrum of pure PDMS that is not a resin used in the silicone rubber composition and has no other functional groups, which is illustrated for reference.

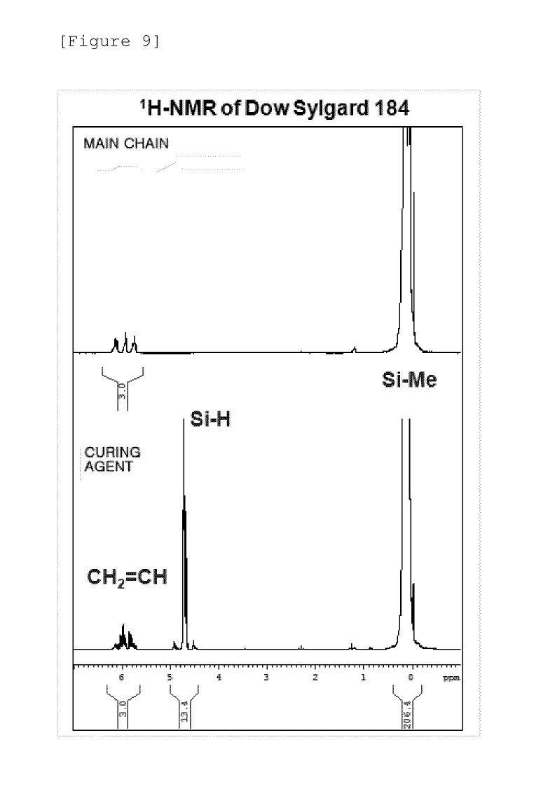

The following FIG. 9 is ¹H-NMR spectra of Sylgard 184 A (main chain) and Sylgard 184 B (curing agent) that are each component of the additional curable silicone rubber composition set used in Comparative Example 1. According to the result of FIG. 9, it can be seen that in the additional curable silicone rubber composition used in Comparative Example 1, the peak corresponding to Si—H is not detected in the main chain but the peak corresponding to Si—H is detected in a respectable amount in the curing agent.

From the results of the following FIGS. 2 and 3, it can be seen that the blanket for printing according to the present invention includes a silicone rubber composition in which a —SiH group does not exist on a surface to prevent a reaction with a conductive metal precursor included in an ink composition and thus suppress a discoloration phenomenon of the blanket and increase a life-span.

1. A blanket for printing, comprising:
a support layer, and
a printing layer laminated on an upper portion of the support layer,
wherein the printing layer includes a cured material of a silicone rubber composition, and a value of the following Equation 1 of the silicone rubber composition is 0 or more and less than 0.001:
$$\frac{{I}_{Si - H , str}}{{I}_{{CH}_{3} , def}} \qquad [ Equation 1 ]$$
in Equation 1,
I_{Si—H,str} means an area of peaks detected in a range of 2150 to 2170 cm⁻¹ in a FT-IR spectrum, and
I_{CH}_{₃}_{,def} means an area of peaks detected in a range of 1250 to 1270 cm⁻¹ in the FT-IR spectrum.

2. The blanket of claim 1, wherein a value of the following Equation 2 of the silicone rubber composition is 0 or more and less than 0.001:
A_{Si—H}/A_{Si—CH3} [Equation 2]
in Equation 2,
A_{Si—H} represents a peak area at d 4-5 ppm in a ¹H-NMR, and
A_{Si—CH3} represents a peak area at d 0-1 ppm in the ¹H-NMR.

3. The blanket of claim 1, wherein the silicone rubber composition includes a main chain and a curing agent.

4. The blanket of claim 3, wherein the silicone rubber composition is a one-fluid type or a two-fluid type.

5. The blanket of claim 1, wherein the value of Equation 1 of the printing layer is 0 or more and less than 0.001.

6. The blanket of claim 2, wherein the value of Equation 2 of the printing layer is 0 or more and less than 0.001.

7. The blanket of claim 1, wherein the support layer includes a polymer film or a metal thin plate.

8. (canceled)

9. The blanket of claim 1, wherein the printing layer does not substantially include a hydrosilyl group (—SiH).

10. (canceled)

11. The blanket of claim 1, wherein the silicone rubber composition includes one kind or more of compounds represented by the following Chemical Formula 1: 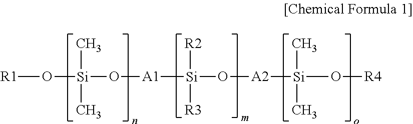
in Chemical Formula 1,
R1 and R4 are the same as or different from each other, and are each independently hydrogen, an alkyl group having 1 to 10 carbon atoms, a cycloalkyl group having 3 to 20 carbon atoms, an ethylene group, or a propylene group, or forming an epoxy group by bonding to adjacent oxygen,
R2 and R3 are the same as or different from each other, and are each independently selected from the group consisting of a hydroxy group; an alkoxy group having 1 to 10 carbon atoms; an epoxy group; an alkyl group having 1 to 10 carbon atoms unsubstituted or substituted by a halogen, an epoxy group, or an aryl group; a cycloalkyl group having 3 to 20 carbon atoms unsubstituted or substituted by a halogen; and an aryl group having 6 to 30 carbon atoms unsubstituted or substituted by a halogen,
A1 and A2 are the same as or different from each other, and are each independently a direct bond; or an olefin-based comonomer, and
n, m, and o are each independently an integer of 0 or more and 5,000 or less, but all of n, m, and o are not 0.

12. The blanket of claim 11, wherein the compound represented by Chemical Formula 1 is any one of compounds represented by the following Chemical Formulas 2-1 to 2-10: 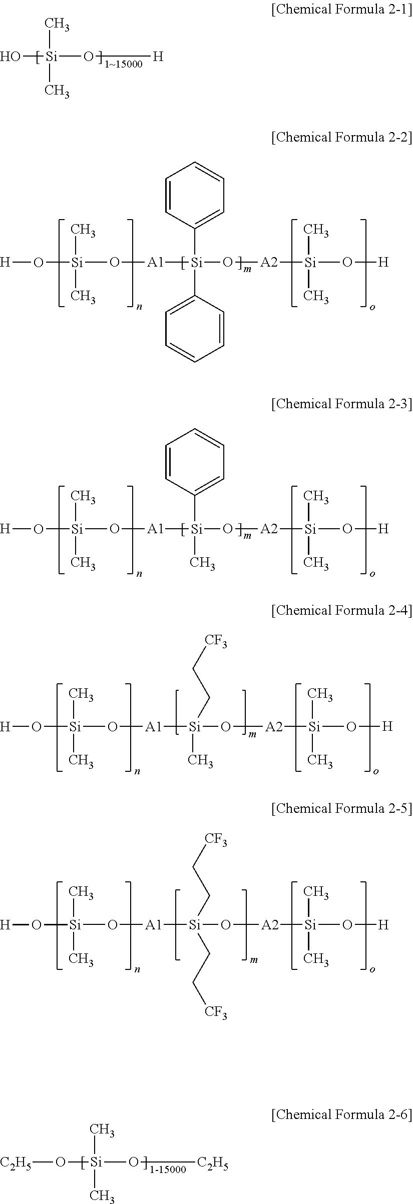 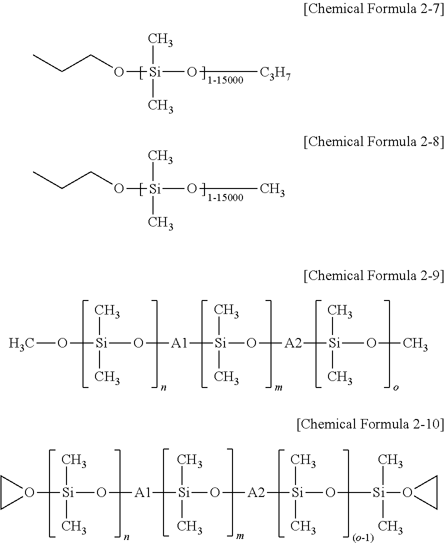
definitions of A1, A2, n, m, and o in Chemical Formulas 2-1 to 2-10 are the same as definitions of Chemical Formula 1.

13. The blanket of claim 3, wherein the curing agent further includes a tin-based compound as a curing catalyst.

14. The blanket of claim 1, wherein a viscosity of the silicone rubber composition is 2,500 cps or more and 100,000 cps or less.

15. The blanket of claim 1, wherein a total weight average molecular weight of the silicone rubber composition is 1,000 or more and 1,000,000 or less.

16. The blanket of claim 4, wherein the silicone rubber composition is the two-fluid type, a weight average molecular weight of the main chain is 1,000 or more and 1,000,000 or less, and a weight average molecular weight of the curing agent is 500 or more and 100,000 or less.

17. (canceled)

18. (canceled)

19. The blanket of claim 1, wherein the shore A hardness of the printing layer is 20 or more and 70 or less, and the thickness is 100 μm or more and 800 μm or less.

20. (canceled)

21. The blanket of claim 20, wherein a thickness of the cushion layer is 450 μm or more and 1,200 μm or less.

22. The blanket of claim 20, further comprising:
a primer layer between the support layer and the printing layer; and between the support layer and the cushion layer.

23. The blanket of claim 1, wherein a total thickness of the blanket for printing is 0.6 mm or more and 2.45 mm or less.

24. A method of manufacturing a blanket for printing, comprising:
1) preparing a support layer, and
2) applying a silicone rubber composition on the support layer and then curing the silicone rubber composition.

25. The method of claim 24, wherein the silicone rubber composition includes one kind or more of compounds represented by the following Chemical Formula 1: 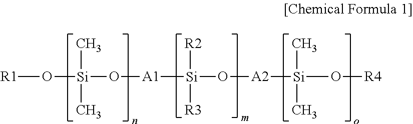
in Chemical Formula 1,
R1 and R4 are the same as or different from each other, and are each independently hydrogen, an alkyl group having 1 to 10 carbon atoms, a cycloalkyl group having 3 to 20 carbon atoms, an ethylene group, or a propylene group, or forming an epoxy group by bonding to adjacent oxygen,
R2 and R3 are the same as or different from each other, and are each independently selected from the group consisting of a hydroxy group; an alkoxy group having 1 to 10 carbon atoms; an epoxy group; an alkyl group having 1 to 10 carbon atoms unsubstituted or substituted by a halogen, an epoxy group, or an aryl group; a cycloalkyl group having 3 to 20 carbon atoms unsubstituted or substituted by a halogen; and an aryl group having 6 to 30 carbon atoms unsubstituted or substituted by a halogen,
A1 and A2 are the same as or different from each other, and are each independently a direct bond; or an olefin-based comonomer, and
n, m, and o are each independently an integer of 0 or more and 5,000 or less, but all of n, m, and o are not 0.
